(19) United States
(12) Patent Application Publication
(10) Pub. No.: US 2024/0104390 A1
(43) Pub. Date: Mar. 28, 2024

(54) APPARATUS AND METHOD FOR QUANTUM MULTI-AGENT META REINFORCEMENT LEARNING

(71) Applicant: Korea University Research and Business Foundation, Seoul (KR)

(72) Inventors: Joongheon KIM, Seoul (KR); Won Joon YUN, Seoul (KR)

(73) Assignee: Korea University Research and Business Foundation, Seoul (KR)

(21) Appl. No.: 18/354,868

(22) Filed: Jul. 19, 2023

(30) Foreign Application Priority Data
Jul. 21, 2022 (KR) 10-2022-0090497

(51) Int. Cl. G06N 3/092

(52) U.S. Cl. CPC G06N 3/092

(57) ABSTRACT

The present invention relates to a quantum multi-agent meta reinforcement learning apparatus, which receives at least one observation value from different single-hop offloading environments, and the apparatus includes: a state encoding unit for calculating an angle along each axis by encoding the at least one observation value, and converting the angle along each axis into a quantum state; a quantum circuit unit for learning the angle along each axis, and overlapping the learned base layer using a controlled X (CX) gate; and a measurement unit for learning the overlapped base layer and measuring an axis parameter. Through the apparatus, the non-stationarity characteristic and credit-assignment problem of the conventional multi-agent reinforcement learning can be solved.

### FIELD OF INVENTION

The present invention relates to an apparatus and method for quantum multi-agent meta reinforcement learning, and more specifically, to an apparatus and method for quantum multi-agent meta reinforcement learning, which performs reinforcement learning using a learning pipeline prepared in advance.

### BACKGROUND OF THE RELATED ART

Recently, development of multi-agent reinforcement learning (MARL) is the main stream in the field of computing hardware and deep learning algorithm.

The multi-agent reinforcement learning is one of reinforcement learning methods that perform learning in a fully centralized method similar to existing single-agent reinforcement learning.

The multi-agent reinforcement learning like this has an advantage of obtaining high rewards by performing learning in a way of interacting with other agents in a scenario in which each agent cooperates or competes with other agents.

However, as each agent interacts with other agents, the multi-agent reinforcement learning has a problem of inviting abnormal rewards and hindering training convergence.

In addition, the multi-agent reinforcement learning has a problem in that it should consider even the problem of unique non-stationarity characteristic and credit-assignment between agents that a multi-agent environment has when learning is progressed.

Therefore, it needs to research and develop techniques that solve the non-stationarity characteristic and credit assignment problem that the multi-agent reinforcement learning has.

### PRIOR ART

Patent Document 1: Korean Patent Laid-Open Publication No. 10-2020-0097787

### SUMMARY OF THE INVENTION

### Problems to be Solved

Therefore, the present invention has been made in view of the above problems, and it is an object of the present invention to provide an apparatus and method for quantum multi-agent meta reinforcement learning, which learns by applying a learnable axis to a quantum circuit so that the quantum circuit may be applied to different environments including multiple agents.

### Means to Solve the Problems

To accomplish the above object, according to one aspect of the present invention, there is provided a quantum multi-agent meta reinforcement learning apparatus, which receives at least one observation value from different single-hop offloading environments, the apparatus comprising: a state encoding unit for calculating an angle along each axis by encoding the at least one observation value, and converting the angle along each axis into a quantum state; a quantum circuit unit for learning the angle along each axis, mapping the angle to a base layer, and overlapping the learned base layer using a controlled X (CX) gate; and a measurement unit for learning the overlapped base layer and measuring an axis parameter.

Here, the quantum circuit unit may update parameters of the base layer through angle learning based on the angle along each axis converted into a quantum state, and the measurement unit may update the axis parameter through local axis learning based on the updated parameters of the base layer, and further perform continuous learning of initializing the axis parameter whenever the single-hop offloading environment changes and updating the axis parameter through the local axis learning for the changed single-hop offloading environment.

More specifically, the quantum circuit unit may update the parameters of the base layer using an angle-pole optimization technique in order to interact with different single-hop offloading environments in which a plurality of agents exists.

Here, the angle-pole optimization technique may be a technique of updating by further adding noise along each axis in the process of updating the parameters of the base layer according to the angle along each axis converted into a quantum state.

In relation thereto, the measurement unit may rotate a learnable axis by learning the parameters of the base layer updated according to any one single-hop offloading environment, and update the axis parameter based on the rotated learnable axis.

In addition, the measurement unit may initialize the axis parameter when the single-hop offloading environment is changed, and update with the axis parameter of the changed single-hop offloading environment using a previously prepared axis memory.

Here, the axis memory may be a memory in which an axis parameter according to each single-hop offloading environment is stored.

On the other hand, according to another aspect of the present invention, there is provided a quantum multi-agent meta reinforcement learning method performed by a quantum multi-agent meta reinforcement learning apparatus, the method comprising the steps of: receiving at least one observation value from different single-hop offloading environments; calculating an angle along each axis by encoding the at least one observation value, and converting the angle along each axis into a quantum state; learning the angle along each axis, mapping the angle to a base layer, and overlapping the learned base layer using a controlled X (CX) gate; and learning the overlapped base layer and measuring an axis parameter.

Here, the step of overlapping the learned base layer may include updating parameters of the base layer through angle learning based on the angle along each axis converted into a quantum state, and the step of measuring an axis parameter may include updating the axis parameter through local axis learning based on the updated parameters of the base layer, and further performing continuous learning of initializing the axis parameter whenever the single-hop offloading environment changes and updating the axis parameter through the local axis learning for the changed single-hop offloading environment.

More specifically, the step of overlapping the learned base layer may include updating the parameters of the base layer using an angle-pole optimization technique in order to interact with different single-hop offloading environments in which a plurality of agents exists.

Here, the angle-pole optimization technique may be a technique of updating by further adding noise along each axis in the process of updating the parameters of the base layer according to the angle along each axis converted into a quantum state.

In relation thereto, the step of measuring an axis parameter may include rotating a learnable axis by learning the parameters of the base layer updated according to any one single-hop offloading environment, and updating the axis parameter based on the rotated learnable axis.

In addition, the step of measuring an axis parameter may include initializing the axis parameter when the single-hop offloading environment is changed, and updating with the axis parameter of the changed single-hop offloading environment using a previously prepared axis memory.

Here, the axis memory may be a memory in which an axis parameter corresponding to each single-hop offloading environment is stored.

### Effects of Invention

According to one aspect of the present invention described above, it is possible to provide users with an apparatus and method for quantum multi-agent meta reinforcement learning having improved performance compared to conventional multi-agent reinforcement learning even when learning through fewer parameters.

In addition, as each agent is applied to different environments having a plurality of agents, the non-stationarity characteristic and credit assignment problem of the conventional multi-agent reinforcement learning can be solved.

### BRIEF DESCRIPTION OF THE DRAWINGS

FIG. 1 is a block diagram showing a quantum multi-agent meta reinforcement learning apparatus according to an embodiment of the present invention.

FIG. 2 is an exemplary view showing the quantum multi-agent meta reinforcement learning apparatus of FIG. 1.

FIG. 3 is an exemplary view for explaining a configuration of performing reinforcement learning by the quantum multi-agent meta reinforcement learning apparatus of FIG. 1.

FIGS. 4 to 7 are views showing experiment results of a quantum multi-agent meta reinforcement learning apparatus according to an embodiment of the present invention.

FIG. 8 is a flowchart illustrating a quantum multi-agent meta reinforcement learning method according to an embodiment of the present invention.

### DETAILED DESCRIPTION OF THE PREFERRED EMBODIMENT

The detailed description of the present invention described below refers to accompanying drawings which show specific embodiments in which the present invention may be practiced as an example. These embodiments are described in detail to be sufficient for those skilled in the art to embody the present invention. It should be understood that various embodiments of the present invention are not necessarily mutually exclusive although they are different from each other. For example, specific shapes, structures, and characteristics described herein may be implemented as different embodiments without departing from the spirit and scope of the present invention. In addition, it should be understood that the locations or arrangements of individual components within each disclosed embodiment may be changed without departing from the spirit and scope of the present invention. Accordingly, the detailed description described below is not to be taken in a limiting sense, and the scope of the present invention, if properly described, is limited only by the appended claims, together with all the scopes equivalent to those claimed in the claims. Like reference numerals in the drawings indicate the same or similar functions throughout various aspects.

Components according to the present invention are components defined not by physical classification but by functional classification, and may be defined by the functions performed by each component. Each component may be implemented as hardware or program codes and processing units that perform respective functions, and functions of two or more components may be implemented to be included in one component. Therefore, the names given to the components in the following embodiments are not to physically distinguish each component, but to imply a representative function performed by each component, and it should be noted that the technical spirit of the present invention is not limited by the names of the components.

Hereinafter, preferred embodiments of the present invention will be described in more detail with reference to the drawings.

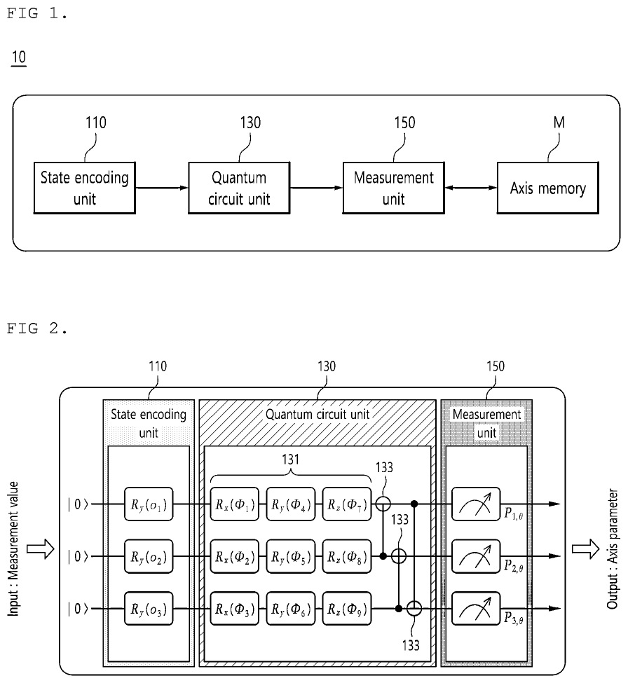

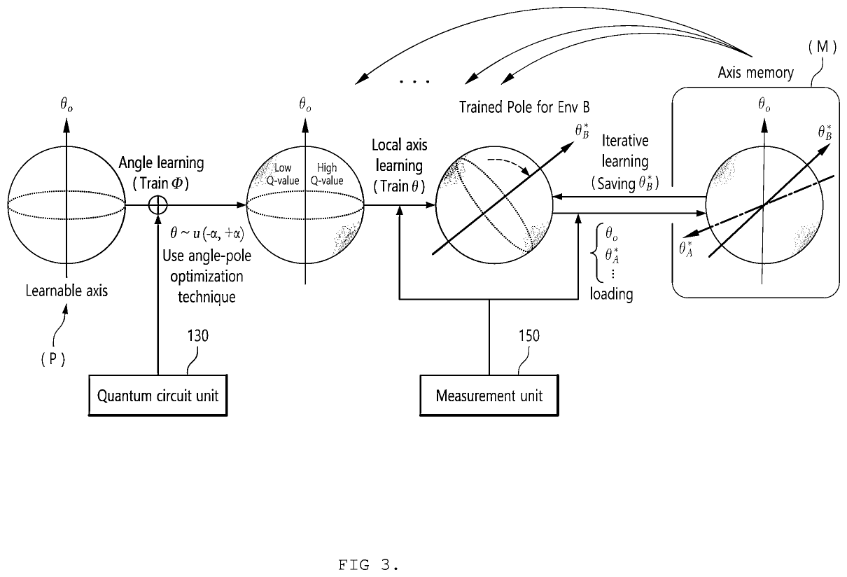

FIG. 1 is a block diagram showing a quantum multi-agent meta reinforcement learning apparatus according to an embodiment of the present invention, FIG. 2 is an exemplary view showing the quantum multi-agent meta reinforcement learning apparatus of FIG. 1, and FIG. 3 is an exemplary view for explaining a configuration of performing reinforcement learning by the quantum multi-agent meta reinforcement learning apparatus of FIG. 1.

The quantum multi-agent meta reinforcement learning apparatus according to an embodiment of the present invention (hereinafter, apparatus) receives at least one observation value from different single-hop offloading environments and performs reinforcement learning.

Referring to FIG. 1, the apparatus includes a state encoding unit 110, a quantum circuit unit 130, and a measurement unit 150 to perform reinforcement learning on the basis of the observation values received from different single-hop offloading environments.

In addition, the apparatus 10 may execute or manufacture various software based on an operating system (OS), i.e., a system. The operating system is a system program that allows the software to use hardware of the apparatus, and may include all computer operating systems such as mobile computer operating systems such as Android OS, iOS, Windows mobile OS, Bada OS, Symbian OS, Blackberry OS, and the like, Windows-based, Linux-based, Unix-based, MAC, AIX, and HP-UX operating systems.

In addition, software (applications) for performing the quantum multi-agent meta reinforcement learning method may be installed and executed in the apparatus 10, and the state encoding unit 110, the quantum circuit unit 130, and the measurement unit 150 may be controlled by software for performing the quantum multi-agent meta reinforcement learning method.

In addition, the apparatus 10 may be provided as a wireless communication device, an unmanned aerial vehicle (UAV), or the like that ensure portability and mobility, and although all types of handheld-based wireless communication devices may be included, such as Personal Communication Systems (PCS), Global System for Mobile communications (GSM), Personal Digital Cellular (PDC), Personal Handyphone System (PHS), Personal Digital Assistant (PDA), International Mobile Telecommunication-2000 (IMT-2000), Code Division Multiple Access-2000 (CDMA-2000), W-Code Division Multiple Access (W-CDMA), Wireless Broadband Internet (Wibro) terminal, smartphone, smart pad, tablet PC, Virtual Reality (VR) device, Head Mounted Display (HMD), and the like, it is not limited thereto.

The state encoding unit 110 calculates an angle along each axis by encoding at least one observation value.

In addition, the state encoding unit 110 converts the calculated angle along each axis into a quantum state.

Referring to FIGS. 2 and 3, the state encoding unit 110 may convert at least one observation value received from any one single-hop offloading environment among different single-hop offloading environments into a quantum state, and transfer the quantum state to the circuit unit 130.

Here, the state encoding unit 110 may calculate x-axis, y-axis, and z-axis angles according to the observation values by mapping the encoded observation values to a three-dimensional sphere having an initial angle set to 0°.

The quantum circuit unit 130 learns the angle along each axis, maps the angle to a base layer 131, and overlaps the learned base layer 131 using a controlled X (CX) gate 133.

The quantum circuit unit 130 is a quantum circuit designed to imitate the calculation procedure of conventional artificial neural networks, and may provide users with performance higher than those of conventional artificial neural networks by overlapping and using a small number of parameters.

In addition, the quantum circuit unit 130 may include a base layer 131 having learnable parameters and a CX gate 133 that overlaps the base layer 131.

Here, the base layer 131 is a single layer including a plurality of rotation gates rotating around a corresponding axis in a three-dimensional sphere, and includes an Rx gate, an Ry gate, and an Rz gate each having learnable parameters.

In addition, the CX gate 133 is a parameterized rotation gate, which overlaps a plurality of rotation gates to convert the probability amplitudes of a quantum state appearing on the x-axis, y-axis, and z-axis, and entangles the converted probability amplitude of each axis.

The quantum circuit unit 130 including the base layer 131 and the CX gate 133 may update the parameters of the base layer 131 through angle learning based on the angle along each axis converted into a quantum state.

Here, the quantum circuit unit 130 may perform angle learning for updating learnable parameters of the base layer in order to interact with different single-hop offloading environments in which a plurality of agents exists.

In addition, the quantum circuit unit 130 may add normalized noise along each axis to each parameter in order to solve a problem generated by the limited size of qubit in a quantum network or a single-hop offloading environment.

More specifically, the quantum circuit unit 130 may perform angle learning for updating the learnable parameters of the base layer 131 using an angle-pole optimization technique on the basis of each axis converted into a quantum state.

Here, the angle-pole optimization technique is a technique of updating by further adding noise along each axis to the parameters of the base layer 131 in the process of updating the learnable parameters of the base layer according to the angle along each axis converted into a quantum state.

In relation thereto, the noise along each axis is noise that affects the learnable parameters, the projection matrix, and the meta-quantum network of the base layer 131, and may be used to calculate a loss function as it is formed of too few qubits to be controlled or to affect the size.

More specifically, the quantum circuit unit 130 may add noise along each axis to the parameters of the base layer 131 using an angle-pole optimization technique, and calculate a temporary difference value on the basis of the parameters of the base layer 131 before noise along each axis is added and the parameters of the base layer 131 to which the noise along each axis is added.

Here, the quantum circuit unit 130 may calculate a loss gradient value as a temporary difference value and update the learnable parameters of the base layer 131 through the calculated loss gradient value.

The loss gradient value may be defined as shown in [Equation 1].

$$ℒ ( ϕ ; θ + \tilde{θ} , ε ) = \text{} \frac{1}{n ( ϵ )} {{\sum }_{< o , a , r , {o}^{′} >} [ r + Q ( {o}^{′} , argmax {a}^{′} ; {ϕ}^{′} , θ ) - Q ( o , a ; ϕ , θ + \tilde{θ} ) ]}^{2} \qquad [ Equation 1 ]$$

Here, ϕ is a variable defining an angle parameter, θ is a variable defining an axis parameter, \tilde{θ} is a variable for a noise value added to the learnable parameters of the base layer, and c is a variable defining the learning data set.

Learning data ε includes <o,a,r,o′> respectively defining current observation information, behavior information, reward information, and observation information of the next state.

In addition, a′ and ϕ′ included in Q(o′,argmaxa′; ϕ′, θ) are variables defining behavior information in the next state and target parameters configuring a target network, and Q(o′,argmaxa′; ϕ′, θ) acquires a′ indicating the highest behavior value in the next observation information.

In addition, (o, a; ϕ, θ+\tilde{θ}) is a variable defining a behavior value function network that calculates a behavior value for current behavior a sampled from the current state information, and learns the behavior value function using the object function described above.

Accordingly, the quantum circuit unit 130 may map an angle along each axis corresponding to the observation value transferred from the single-hop offloading environment to the surface of a three-dimensional sphere named Bloch sphere by updating the learnable parameters of the base layer 131.

The measurement unit 150 learns the overlapped base layer 131 and measures an axis parameter.

To this end, the measurement unit 150 may update the axis parameter through local axis learning based on the learnable parameters of the base layer 131 updated by the quantum circuit unit 130.

Here, the axis parameter is a learnable axis P formed on the three-dimensional sphere mapped by the quantum circuit unit 130 as shown in FIG. 3, and the measurement unit 150 may prepare in advance the parameter of the learnable axis P initialized to 0.

More specifically, the measurement unit 150 may rotate the learnable axis P formed on the three-dimensional sphere by learning the learnable parameter values of the base layer 131 updated according to any one single-hop offloading environment.

In addition, the measurement unit 150 may update the axis parameter based on the rotated learnable axis P.

Here, the measurement unit 150 may use multi-agent reinforcement learning (Centralized Training and Decentralized Execution; CTDE) to update the axis parameter.

In addition, the measurement unit 150 may calculate a loss function to update the axis parameter.

The loss function may be defined as shown in [Equation 2].

$$ℒ ( Θ ; ϕ , ε , {Θ}^{′} ) = \frac{1}{\vert ε \vert} {\sum }_{τ \sim ε} [ \text{} r + \text{} \frac{1}{N} {\sum }_{n = 1}^{N} {( \tilde{Q} ( {o}^{′ n} , argmax {a}^{′ n} ; ϕ , {θ}^{′ n} ) - \tilde{Q} ( {o}^{n} , {a}^{n} ; ϕ , {θ}^{n} ) )}^{2} \qquad [ Equation 2 ]$$

Here, τ=<o,a,r,o′> and Θ≙{θ′ⁿ}ₙ₌₁^{N} are variables that define the single-hop offloading environment in the axis parameter of each of all agents and a conversion sampled from the learning target.

Accordingly, the measurement unit 150 may calculate a loss function used for update according to a parameter movement rule, and may update the axis parameter based on the calculated loss function and the rotated learnable axis P.

In addition, the quantum circuit unit 130 and the measurement unit 150 may perform angle learning and local axis learning through Algorithm 1 shown in [Table 1].

TABLE 1
Algorithm 1: Training Procedure

| | |
|---|---|
| 1 | Initialize parameters, ϕ ← ϕ₀, ϕ′ ← ϕ₀, θ ← 0, and ∀θⁿ ← 0; |
| 2 | while Meta-QNN angle training do |
| 3 | \| Generate an episode, ε ← {(o₀, a₀, r₁,..., o_{T-1}, a_{T-1}, r_{T})}, s.t. α~π_{ϕ, θ+}\dot{_{θ}}, a\α~π ; |
| 4 | \| Sampling angle noise for every step, \ddot{θ} ~ [symbol] [−α, α] ; |
| 5 | \| Compute temporal difference, [symbol] (ϕ; θ + \tilde{θ}, ε), and its gradient ∇_{ϕ} [symbol] (ϕ; θ + \ddot{θ}, ε); |
| 6 | \| Update meta Q-network parameters, ϕ ← ϕ − η∇_{ϕ} [symbol] (ϕ; θ + \tilde{θ}, ε); |
| 7 | \|_if Target update period then ϕ′ ← ϕ; |
| 8 | while Local QNN Pole Training do |
| 9 | \| Generate an episode ε ← {(o₀, a₀, r₁,..., o_{T-1}, a_{T-1}, r_{T})}, s.t. ∀αⁿ ~ π_{ϕ, θ}_{ⁿ}; |
| 10 | \| Compute temporal difference [symbol] _{α} (Θ; ϕ, ε), and its gradient ∇_{Θ} [symbol] ₒ (Θ; ϕ, ε) using (3); |
| 11 | \| Update Θ ← Θ − η∇_{Θ} [symbol] ₙ (Θ; ϕ, ε); |
| 12 | \|_if Target update period then Θ′ ← Θ; |

Meanwhile, the measurement unit 150 may further perform continuous learning that initializes the axis parameter according to different single-hop offloading environments.

More specifically, the measurement unit 150 may further perform continuous learning of initializing the axis parameter whenever the single-hop offloading environment changes, and updating the axis parameter through local axis learning for the changed single-hop offloading environment.

In relation thereto, the axis memory M is a memory in which the axis parameter value updated by the measurement unit 150 according to each single-hop offloading environment is stored, and there is a characteristic in that the number of parameters is very small, and performance of the quantum multi-agent meta reinforcement learning apparatus 10 is changed greatly.

Accordingly, the measurement unit 150 may adapt to each of the different single-hop offloading environments more quickly to update the parameter values and measure the updated values, and may store parameter values corresponding to the different single-hop offloading environments in the axis memory M.

In addition, the measurement unit 150 may initialize the axis parameter to 0 to perform local axis learning more quickly by finely adjusting the axis for different single-hop offloading environments.

The measurement unit 150 may perform continuous learning through Algorithm 2 shown in [Table 2].

TABLE 2
Algorithm 2: Continual Learning Procedure

Notation. θₚ: the pole from pole memory;
Initialization. ∀ϕ, ϕ′ ← ϕ₀, ∀θ, θⁿ ← 0;
while Meta-QNN angle training do
| ε ← ∅;
| for env ∈ set of environment do
| | Generate an episode, εₜₘₚ;
| |_ε ← ε ∪ εₜₘₚ;
| ϕ ← ϕ − η∇_{ϕ} [symbol] (ϕ; θ + \tilde{θ}, ε);
|_if Target update period then ϕ′ ← ϕ;
while Continual Learning do
| Initialize ∀θⁿ ← θₚ, η ← ηₒ;
|_Local QNN Pole Training in Algorithm 1;

Accordingly, the quantum multi-agent meta reinforcement learning apparatus 10 is provided with the state encoding unit 110, the quantum circuit unit 130, and the measurement unit 150, and may solve the non-stationarity characteristic and credit-assignment problem of the conventional multi-agent reinforcement learning by performing reinforcement learning using an angle-pole optimization technique, local axis learning performed through conventional multi-agent reinforcement learning, and continuous learning using the axis memory M in which learnable axis parameter values are stored.

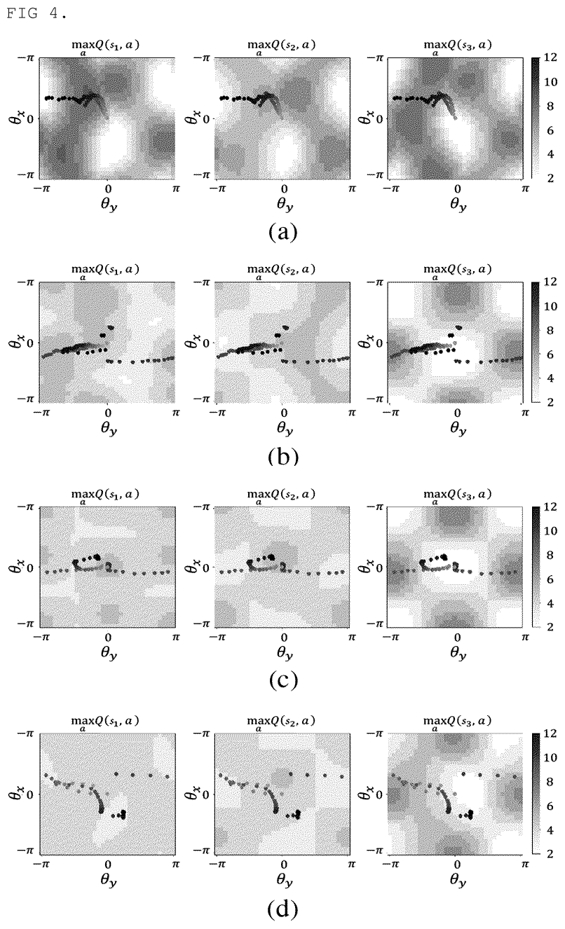

FIGS. 4 to 7 are views showing experiment results of a quantum multi-agent meta reinforcement learning apparatus according to an embodiment of the present invention.

In an experiment performed to explain the effect of noise in the quantum multi-agent meta reinforcement learning apparatus 10 according to an embodiment of the present invention, a quantum multi-agent meta reinforcement learning apparatus 10 without applying normalized noise, and a quantum multi-agent meta reinforcement learning apparatus 10 applying normalized noise of 30°, 60°, and 90° are used.

FIG. 4 is a view showing experiment results confirmed in this experiment, and (a) of FIG. 4 shows a quantum multi-agent meta reinforcement learning apparatus 10 to which normalized noise is not applied, (b) of FIG. 4 shows a quantum multi-agent meta reinforcement learning apparatus 10 to which normalized noise of 30° is applied, and (c) and (d) of FIG. 4 show quantum multi-agent meta reinforcement learning apparatuses 10 to which normalized noise of 60° and 90° is applied.

Through FIG. 4, it can be confirmed that distribution of action values of all the quantum multi-agent meta reinforcement learning apparatuses 10 has both high and low values.

However, it can be confirmed that the minimum and maximum values are uniformly distributed in (b), (c) and (d), which are distributions of action values of the quantum multi-agent meta reinforcement learning apparatus 10 to which normalized noise is applied.

In addition, it can be confirmed that the quantum multi-agent meta reinforcement learning apparatus 10 to which normalized noise is applied has a large variance of action value.

Through this experiment, it can be confirmed that as the parameters of the learnable axis P are learned in various directions, the momentum is great.

Accordingly, through this experiment, it can be confirmed that the quantum multi-agent meta reinforcement learning apparatus 10 is affected by the normalized noise.

Meanwhile, in an experiment performed to explain the need for the angle-pole optimization technique in the quantum multi-agent meta reinforcement learning apparatus 10 according to an embodiment of the present invention, angle learning and local axis learning are performed 3,000 times and 20,000 times, respectively, in a plurality of quantum multi-agent meta reinforcement learning apparatuses 10 used in the experiment of FIG. 4.

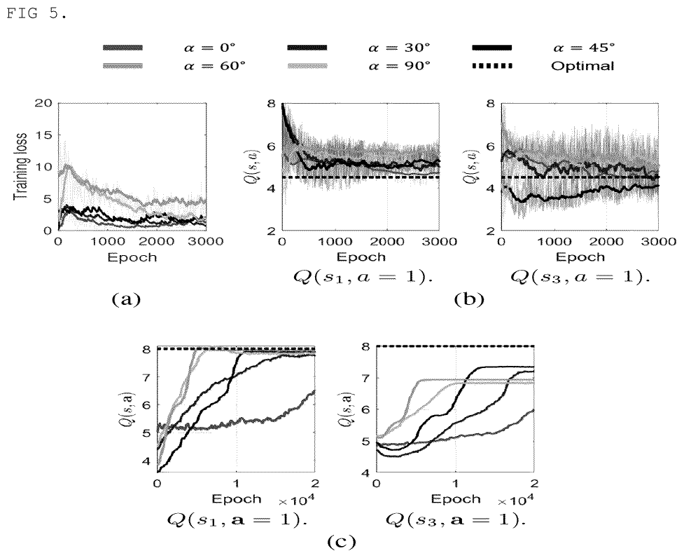

FIG. 5 is a view showing experiment results confirmed in this experiment, and (a) of FIG. 5 shows the learning curve of the quantum multi-agent meta reinforcement learning apparatus 10 corresponding to a training loss in an angular training process, (b) of FIG. 5 shows a numerical result of a plurality of quantum multi-agent meta reinforcement learning apparatuses 10 that has iteratively performed angle learning 3,000 times, and (c) of FIG. 5 shows a numerical result of a plurality of quantum multi-agent meta reinforcement learning apparatuses 10 that has iteratively performed local axis learning 20,000 times.

Through (a) of FIG. 5, it can be confirmed that the training loss is proportional to the strength of the normalized noise since the boundary of the normalized noise is a monotonic decreasing function of α∈[0,π/2].

In addition, through (b) of FIG. 5, it can be confirmed that as the boundary of the normalized noise increases, the distance between the action value of the quantum multi-agent meta reinforcement learning apparatus 10 and the optimal action value increases.

In addition, through (c) of FIG. 5, it can be confirmed that as the boundary of the normalized noise decreases, the action value of the quantum multi-agent meta reinforcement learning apparatus 10 slowly converges to the optimal action value, and as the boundary of the normalized noise increases, the action value quickly converges to the optimal action value.

Through this, it can be confirmed that the angle-pole optimization technique converges slowly when the quantum multi-agent meta reinforcement learning apparatus 10 performs angle learning, but the angle-pole optimization technique converges quickly when the quantum multi-agent meta reinforcement learning apparatus 10 performs local axis learning.

Accordingly, the need of the angle-pole optimization technique can be confirmed through this experiment.

Meanwhile, in an experiment performed to explain the effect of the axis memory M in the quantum multi-agent meta reinforcement learning apparatus 10 according to an embodiment of the present invention, a quantum multi-agent meta reinforcement learning apparatus 10 to which the axis memory M and the angle-pole optimization technique are applied, a quantum multi-agent meta reinforcement learning apparatus 10 to which only the axis memory M is applied, a quantum multi-agent meta reinforcement learning apparatus 10 to which only the angle-pole optimization technique is applied, and a quantum multi-agent meta reinforcement learning apparatus 10 to which both the axis memory M and the angle-pole optimization technique are not applied are used, and EnvA and EnvB, which are different single-hop offloading environments with different reward functions, are considered.

In addition, a scenario is considered, in which the single-hop offloading environment is initially set to EnvA, changed from EnvA to EnvB, and then changed from EnvB to EnvA in the process of iteratively performing angle learning 5,000 times and iteratively performing local width learning 10,000 times by each quantum multi-agent meta reinforcement learning apparatus 10.

FIG. 6 is a view showing experiment results confirmed in this experiment, a=30, w.PM indicates a quantum multi-agent meta reinforcement learning apparatus 10 to which the axis memory M and the angle-pole optimization technique are applied, a=0, w.PM indicates a quantum multi-agent meta reinforcement learning apparatus 10 to which only the axis memory M is applied, a=30, w/o.PM indicates a quantum multi-agent meta reinforcement learning apparatus 10 to which only the angle-pole optimization technique is applied, and a=0, w/o.PM indicates a quantum multi-agent meta reinforcement learning apparatus 10 to which both the axis memory M and the angle-pole optimization technique are not applied.

Through FIG. 6, it can be confirmed that all the quantum multi-agent meta reinforcement learning apparatuses 10 used in the experiment adapt better in EnvB than in EnvA.

In addition, it can be confirmed that at 1 where the single-hop offloading environment is initially set to EnvA, the initial tangent according to the optimization distance of the quantum multi-agent meta reinforcement learning apparatuses 10 to which the axis memory M is applied shows a very steep rising curve.

In addition, it can be confirmed that at 2 where the single-hop offloading environment is changed from EnvA to EnvB, the quantum multi-agent meta reinforcement learning apparatuses 10 to which the axis memory M is not applied do not adapt to EnvB, whereas the quantum multi-agent meta reinforcement learning apparatus 10 to which the axis memory M and the angle-pole optimization technique are applied adapts to EnvB.

In addition, it can be confirmed that at 3 where the single-hop offloading environment is changed from EnvB to EnvA, the quantum multi-agent meta reinforcement learning apparatus 10 to which the axis memory M and the angle-pole optimization technique are applied adapts to EnvA at a speed faster than adapting to EnvB.

Through this, it can be confirmed that the quantum multi-agent meta reinforcement learning apparatus 10 to which the axis memory M is applied adapts to the single-hop offloading environment faster than the quantum multi-agent meta reinforcement learning apparatus 10 to which the axial memory M is not applied.

Accordingly, the effect of the axial memory M can be confirmed through the experiment.

Meanwhile, in an experiment performed to verify generalization performance in different environments in the quantum multi-agent meta reinforcement learning apparatus 10 according to an embodiment of the present invention, the experiment is performed in the same environment as the experiment performed to explain the effect of the axis memory M in the quantum multi-agent meta reinforcement learning apparatus 10.

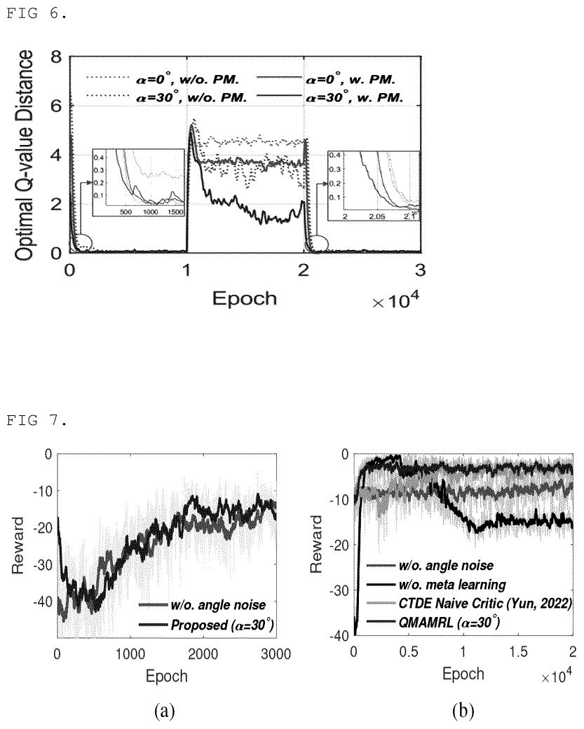

FIG. 7 is a view showing experiment results confirmed in this experiment, and (a) of FIG. 7 is a view showing performance of the axis memory M and the angle-pole optimization technique output according to a result of performing angle learning by the quantum multi-agent meta reinforcement learning apparatus 10 of the present invention, and (b) of FIG. 7 is a view showing the performance difference according to whether or not the angle-pole optimization technique is applied in the local axis learning.

Through (a) of FIG. 7, it can be confirmed that the performance difference of the angle learning according to presence of the angle-pole optimization technique is not large.

When the red line is compared with the blue line in (b) of FIG. 7, it can be confirmed that there is a big difference in the performance of the local axis learning according to presence of the angle-pole optimization technique.

In addition, when the blue line is compared with the green line in (b) of FIG. 7, it can be confirmed that the quantum multi-agent meta reinforcement learning apparatus 10 according to an embodiment of the present invention converges to different environments faster than the apparatus performing conventional multi-agent reinforcement learning.

Through this, it can be confirmed that the quantum multi-agent meta reinforcement learning apparatus 10 according to an embodiment of the present invention is excellent in the inferential learning beyond the finite horizon in the single-hop offloading environment.

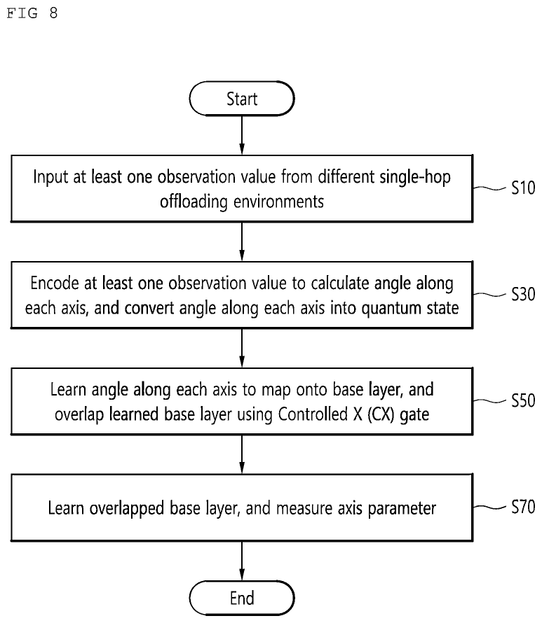

Meanwhile, FIG. 8 is a flowchart illustrating a quantum multi-agent meta reinforcement learning method according to an embodiment of the present invention, and since the quantum multi-agent meta reinforcement learning method according to an embodiment of the present invention proceeds in the substantially same configuration as the quantum multi-agent meta reinforcement learning apparatus 10 shown in FIGS. 1 to 3, the same reference numerals are given to the components the same as those of the quantum multi-agent meta reinforcement learning apparatus 10 of FIGS. 1 to 3, and repeated descriptions will be omitted.

Referring to FIG. 8, the quantum multi-agent meta reinforcement learning method according to an embodiment of the present invention is performed by a quantum multi-agent meta reinforcement learning apparatus (hereinafter, apparatus) 10.

First, the apparatus 10 receives at least one observation value from different single-hop offloading environments (S10).

Thereafter, the apparatus 10 encodes at least one observation value to calculate an angle along each axis, and converts the angle along each axis into a quantum state (S30).

Then, the apparatus 10 learns the angle along each axis, maps the angle onto the base layer 131, and overlaps the learned base layer 131 using a Controlled X (CX) gate (S50).

At this point, the apparatus 10 may update parameters of the base layer 131 through angle learning based on the angle along each axis converted into a quantum state.

Here, the apparatus 10 may update parameters of the base layer 131 using an angle-pole optimization technique to interact with different single-hop offloading environments in which a plurality of agents exists.

In relation thereto, the angle-pole optimization technique may be a technique of updating by further adding noise along each axis in the process of updating the parameters of the base layer 131 according to the angle along each axis converted into a quantum state.

Meanwhile, the apparatus 10 learns the overlapped base layer 131 and measures an axis parameter (S70).

Here, the apparatus 10 may update the axis parameter through local axis learning based on the updated parameters of the base layer 131.

More specifically, the apparatus 10 may rotate the learnable axis P by learning the parameters of the base layer 131 updated according to any one single-hop offloading environment, and update the axis parameter based on the rotated learnable axis P.

In addition, the apparatus 10 may further perform continuous learning of initializing the axis parameter whenever the single-hop offloading environment changes, and updating the axis parameter through local axis learning for the changed single-hop offloading environment.

More specifically, the apparatus 10 may initialize the axis parameter when the single-hop offloading environment is changed, and update with the axis parameter of the changed single-hop offloading environment using a previously prepared axis memory M.

Here, the axis memory M may be a memory in which an axis parameter corresponding to each single-hop offloading environment is stored.

Therefore, the quantum multi-agent meta reinforcement learning apparatus 10 may solve the non-stationarity characteristic and credit assignment problem of the conventional multi-agent reinforcement learning by performing the quantum multi-agent meta reinforcement learning method.

The quantum multi-agent meta reinforcement learning method of the present invention as described above may be implemented in the form of program instructions that can be executed through various computer components and recorded in a computer-readable recording medium. The computer-readable recording medium may store program instructions, data files, data structures, and the like alone or in combination.

The program instructions recorded in the computer-readable recording medium may be specially designed and configured for the present invention or may be known to and used by those skilled in the field of computer software.

Examples of the computer-readable recording medium include magnetic media such as hard disks, floppy disks, and magnetic tapes, optical media such as CD-ROMs and DVDs, magneto-optical media such as floptical disks, and hardware devices specially configured to store and execute program instructions, such as ROM, RAM, flash memory, and the like.

Examples of the program instructions include high-level language codes that can be executed by a computer using an interpreter, as well as machine language codes such as those produced by a compiler. The hardware devices described above may be configured to operate as one or more software modules to perform the processes according to the present invention, and vice versa.

According to one aspect of the present invention described above, it is possible to provide users with an apparatus and method for quantum multi-agent meta reinforcement learning having improved performance compared to conventional multi-agent reinforcement learning even when learning through fewer parameters.

In addition, as each agent is applied to different environments having a plurality of agents, the non-stationarity characteristic and credit assignment problem of the conventional multi-agent reinforcement learning can be solved.

Although various embodiments of the present invention have been shown and described above, the present invention is not limited to the specific embodiments described above, and of course, various modified embodiments are possible by those skilled in the art without departing from the gist of the present invention claimed in the claims, and these modified embodiments should not be individually understood from the technical spirit or prospect of the present invention.

### DESCRIPTION OF SYMBOLS

10: Quantum multi-agent meta reinforcement learning apparatus
110: State encoding unit
130: Quantum circuit unit
131: Base layer
133: CX gate
150: Measurement unit
P: Learnable axis
M: Axis memory

What is claimed is:

1. A quantum multi-agent meta reinforcement learning apparatus, which receives at least one observation value from different single-hop offloading environments, the apparatus comprising:
a state encoding unit for calculating an angle along each axis by encoding the at least one observation value, and converting the angle along each axis into a quantum state;
a quantum circuit unit for learning the angle along each axis, mapping the angle to a base layer, and overlapping the learned base layer using a controlled X (CX) gate; and
a measurement unit for learning the overlapped base layer and measuring an axis parameter.

2. The apparatus according to claim 1, wherein the quantum circuit unit updates parameters of the base layer through angle learning based on the angle along each axis converted into a quantum state, and the measurement unit updates the axis parameter through local axis learning based on the updated parameters of the base layer, and further performs continuous learning of initializing the axis parameter whenever the single-hop offloading environment changes and updating the axis parameter through the local axis learning for the changed single-hop offloading environment.

3. The apparatus according to claim 2, wherein the quantum circuit unit updates the parameters of the base layer using an angle-pole optimization technique in order to interact with different single-hop offloading environments in which a plurality of agents exists.

4. The apparatus according to claim 3, wherein the angle-pole optimization technique is a technique of updating by further adding noise along each axis in the process of updating the parameters of the base layer according to the angle along each axis converted into a quantum state.

5. The apparatus according to claim 4, wherein the measurement unit rotates a learnable axis by learning the parameters of the base layer updated according to any one single-hop offloading environment, and updates the axis parameter based on the rotated learnable axis.

6. The apparatus according to claim 5, wherein the measurement unit initializes the axis parameter when the single-hop offloading environment is changed, and updates with the axis parameter of the changed single-hop offloading environment using a previously prepared axis memory.

7. The apparatus according to claim 6, wherein the axis memory is a memory in which an axis parameter according to each single-hop offloading environment is stored.

8. A quantum multi-agent meta reinforcement learning method performed by a quantum multi-agent meta reinforcement learning apparatus, the method comprising the steps of:
receiving at least one observation value from different single-hop offloading environments;
calculating an angle along each axis by encoding the at least one observation value, and converting the angle along each axis into a quantum state;
learning the angle along each axis, mapping the angle to a base layer, and overlapping the learned base layer using a controlled X (CX) gate; and
learning the overlapped base layer and measuring an axis parameter.

9. The method according to claim 8, wherein the step of overlapping the learned base layer includes updating parameters of the base layer through angle learning based on the angle along each axis converted into a quantum state, and the step of measuring an axis parameter includes updating the axis parameter through local axis learning based on the updated parameters of the base layer, and further performing continuous learning of initializing the axis parameter whenever the single-hop offloading environment changes and updating the axis parameter through the local axis learning for the changed single-hop offloading environment.

10. The method according to claim 9, wherein the step of overlapping the learned base layer includes updating the parameters of the base layer using an angle-pole optimization technique in order to interact with different single-hop offloading environments in which a plurality of agents exists.

11. The method according to claim 10, wherein the angle-pole optimization technique is a technique of updating by further adding noise along each axis in the process of updating the parameters of the base layer according to the angle along each axis converted into a quantum state.

12. The method according to claim 11, wherein the step of measuring an axis parameter includes rotating a learnable axis by learning the parameters of the base layer updated according to any one single-hop offloading environment, and updating the axis parameter based on the rotated learnable axis.

13. The method according to claim 12, wherein the step of measuring an axis parameter includes initializing the axis parameter when the single-hop offloading environment is changed, and updating with the axis parameter of the changed single-hop offloading environment using a previously prepared axis memory.

14. The method according to claim 13, wherein the axis memory is a memory in which an axis parameter corresponding to each single-hop offloading environment is stored.
